(19) United States
(12) Patent Application Publication
(10) Pub. No.: US 2009/0068613 A1
(43) Pub. Date: Mar. 12, 2009

(54) PORTABLE COLOR CORRECTED OVER HEAD DENTAL LIGHT TO MATCH SHADES OF TEETH WITH TRUE CHROMATIC EFFICIENCY AND TO ACCELERATE TOOTH WHITENING

(76) Inventors: Daniel Wang, Walnut, CA (US); Alan Austin Creamer, Walnut, CA (US)

Correspondence Address: JIANPING SHEN, 21078 COMMERCE POINTE DR., WALNUT, CA, 91789, US

(21) Appl. No.: 11/852,290

(22) Filed: Sep. 8, 2007

(51) Int. Cl. A61C 3/00

(52) U.S. Cl. 433/29

(57) ABSTRACT

A portable color corrected light for the correct matching of tooth shades and acceleration of tooth whitening has been developed. In order to accurately match the tint and hue (true color) of teeth, the device provides 5500 to 6500 Kelvin, ambient-independent light with the ability to block or overwhelm ambient light to get a precise “color” reading of that tooth. The same light can accelerate the tooth whitening process with the addition of photo-accelerators to increase the decomposition of H₂O₂ or other peroxide whitening material. In addition, the same light can also serve as a dental operatory light which provides a closer to daylight illumination than conventional halogen dental lights.

### FIELD OF THE INVENTION

The present invention relates to a system for bleaching discolored teeth by removing the pigments (coloration, discoloration) deposited on them; more particularly, for bleaching discolored teeth under irradiation from LED light by photo-catalytic action or by accelerating the decomposition of H₂O₂, wherein the chemical agent is applied to the surface of the teeth and irradiated with the light, especially with a color corrected light. The irradiation energy of a narrow wavelength band with no ultraviolet component emitted from an LED light can be used to obtain a high bleaching effect of the teeth and to reduce the heat applied to the teeth to a low level.

This application claims the benefit of U.S. Provisional application No. 60/728,114 filed on Oct. 19, 2005, Confirmation No. 2435, which pertains generally to the field of apparatus for a portable light that can be easily moved between different dental rooms with a shield that screens out ambient light that could render incorrect shade matches because it is not the proper corrected color temperature under controlled ideal illumination conditions (5500 to 7500 Kelvin) required for the tooth matching process.

Moreover the system could be used in conjunction with a computer storing an existing shade guide like the VITA SHADE GUIDE™ or other available guide. The operator would take a digital picture of the patient's teeth using a digital camera and have the computer match the shade to the existing VITA™ shade guide to get the match for a “second opinion” and/or verification of his own visual shade match.

Furthermore, if combined with a convergent lens added on to the LED light source, the system could also serve as an operatory light in the dental room. The higher optical efficiency of LED diodes will provide a more effective illumination effect than the regular less than 5000 Kelvin halogen lights which are commonly used in dental offices. Furthermore, Patients with Xeroderma Pigmentosum or other light sensitive diseases can be treated safely with this light because there is no UV light associated with the spectrum of an LED light output.

Another aspect of the invention is that the device can be reduced to a hand-held light, either battery operated or wired to the wall socket, for the purpose of matching shades with 6500 Kelvin and for tooth whitening with color corrected light.

### BACKGROUND OF THE INVENTION

In recent years, in dental therapy, demands have been increasing for whitening the teeth as an important element in facial beauty. Several methods have been proposed in the past for the cosmetic improvement of discolored teeth, among which bleaching may be considered as a highly effective method. Bleaching is essentially a method for decolorizing colored substances by means of a chemical reaction.

In the past there have been various reports of bleaching agents comprising a variety of chemical agents, such as 7% to 50% H₂O₂, with combined use of light and heat on the aqueous hydrogen peroxide or other peroxide whitener. Many other bleaching methods have also been reported as from U.S. Pat. Nos. 6,949,240, 6,884,426, 6,783,363 6,733,290, 6,730,316, 6,638,496, 6,616,447, 6,254,388, 6,155,832, and 6,102,705. But none of them used a whitening lamp that features a tooth color-correction function, so that a perfect color matching of teeth was not possible unless by using other expensive approaches difficult to achieve in the dental operatory office.

Perception of the human eye varies under different lighting conditions. The retina of the human eye is made up of color receptors or cones where 64% are red sensitive, 32% are green sensitive and about 2% are blue sensitive which is the so-called RGB of red, green and blue. An intensity of 50 foot candles is required for the human eye to comfortably perceive color. Another critical factor is the color temperature of the light. For any light to be used successfully it must circumvent ambient lighting and/or significantly block it from view. A light device with a correlated color temperature of 6,500 Kelvin and 100 foot candles intensity, or better, is needed to illuminate teeth and shade guides; only then can true color matching be accomplished. The color temperature must be neutral in order NOT to introduce a color change of the teeth. The mathematical representation of average north sky at midday is 6504/Kelvin which is the most common daylight illumination to be used. A big challenge in conservative cosmetic dentistry of restoring only one anterior tooth is matching the proper colors of the contra-lateral teeth. The ability to correctly analyze the color quality at the time of shade determination can be the most important factor in the success of sending ideal instructions to the laboratory technician and proper shade matching can be more controlled when the decision is made under controlled ideal illumination conditions.

For optimum color matching, a lighting product should have a color rendering index (CRI) of 95 or higher. The CRI reflects how closely the intensity of the light at each wavelength matches daylight or light with a color temperature in the range of 5500 to 7500 Kelvin. A CRI of 100 is a perfect match to daylight and a CRI of 90 or better is considered acceptable for shade matching. The ideal color temperature is 6500 Kelvin. Lights used in dental offices today have color peaks and valleys in the output spectrum thus causing inaccuracies in making a color match of teeth. Color matching will vary from room to room depending on the ambient light sources in each room. Thus restorations may not perfectly match the existing teeth or other restorations that the patient may have. Dentists have found that by utilizing special “full-spectrum” lights in their operation, they are better able to offer more accurate and precise color matching for crowns, composite fillings and other restorations than if only using fluorescent bulbs and other lights found in dental offices. Even light through a window will change during the day and depending on the weather. This has been a problem for cosmetic dentists in meeting the expectations of patients today.

The practitioner can hardly achieve the same shade match in different rooms when other different light sources are present. These different lights make shade matching a matter of guesswork and not the precise practice needed for a true color restoration. Practitioners in some cases have to repair and change restorations that have not been color matched properly, which is costly to the dentist or possibly disastrous to a medical doctor's diagnosis when true color matching or identification is needed. Proper lighting can also be used in the home or salon to compare make-up and match the shade to individual desires. It can also be used in medical applications where the proper shade of skin or other tissue needs to be viewed in “daylight”, 5500 to 6500 Kelvin being the perfect light output. Note that this color temperature is also used by the print industry to match the color of printed material. Diagnosis of teeth or tissue will be vastly more accurate when viewed in color corrected light. Moreover, color corrected light pertains specifically to such apparatuses as are used for the acceleration of tooth whitening procedures with the addition of photo-sensitive material such as ionic silver, keratin or any other photo-reactive substance for better whitening results in less time.

### SUMMARY OF THE PRESENT INVENTION

In view of the limitations existing in the prior art, the present invention provides a new and useful color corrected light source at 5500 to 6500 Kelvin to be used in any room because of its easy portability. This light and its source are simpler in construction, more universally usable, and more versatile in operation than any known apparatus of this kind.

The purpose of the present invention is to provide a new method to color match teeth or tissue in “daylight”, determined to be a color temperature of 5500 to 6500 Kelvin, using many novel features not offered by prior apparatuses. The present invention also has the capability to accelerate tooth whitening procedures.

The light “head” contains LEDs rated at 5500 to 6500 Kelvin (Luxeon 3 Watt LED from Lumileds Inc. or Golden Dragon 3 Watt LED from Osram) at the distal portion of the total light head system. Anywhere from 1 to 200 LED lights are arranged in a row, usually in the shape of the patient's arch. The LED lights are a combination of different colors so that, for example, when the function on the control panel is set to “color-correction”, the white bulbs are switched on, whereas when the function is set to “whitening”, the white or blue bulbs are on. The light has a timer controller and the printed circuit board (PCB) allows the operator to set a predetermined amount of exposure time for the patient. The time interval ranges from a few seconds to hours.

The light head is attached to a pole so as to be able to attain the height needed for the patient, and the pole is connected proximally to a portable stand. The light head is articulated and is arranged to direct the light on the tooth surfaces, with outside light being blocked, eliminated and/or diminished. The stand may optionally have wheels attached to its proximal end.

The light head features a tooth color correction function. The color correction is achieved by using a specially designed 5500 to 6500 Kelvin light, which is close to natural sunlight. This specific light color is also used by the print industry to assure that their colors are matched flawlessly. Dental offices usually have many light sources, all of which have peaks in the red, blue or green parts of the spectrum, thereby making the matching of a patient's tooth color according to a tooth-shade guide a mere close approximation at best. By eliminating the interfering ambient light and replacing it with a color controlled light, a dental clinician is able to match shade and hue perfectly for a restoration of any kind. The light head in this invention offers a true color solution to match restorations or perform a true color analysis of teeth.

The light head can have a detachable shield added to eliminate the ambient light that could affect the color correction for proper matching of shades. Thus, only the 5500 to 6500 Kelvin light would reach the patient. However, in many cases the LED light itself may be bright enough with its proximity very close to the patient's teeth or other tissue to overwhelm the ambient light and therefore no shade would be needed. The distance from the color corrected light to the teeth for color matching can be in the range of 0.2 cm to 6 cm, with similar distances for tissue examination and for the whitening process.

The system can be used in conjunction with a computer storing an existing shade guide like the VITA SHADE GUIDE™ or others available. The operator takes a digital picture of the patient's teeth using a digital camera (not shown in this invention) and has the computer match the shade to the closest existing VITA SHADE GUIDE™ or other to get the shade match for a “second opinion” of his own visual shade match. The LED light source is used to take the picture of the shade guide and the teeth; using the same light source results in a perfect match or as close a match as possible.

If a convergent lens is added to the output side of the LED light source, the system can also serve as a dental operatory light. Because of the higher optical efficiency of LED diodes, this brighter light source will provide a more effective illumination effect with a closer approximation to natural daylight than the commonly-used 5000 Kelvin or less halogen lights.

For home use or other portable convenience, this professional office-using device can be reduced to a hand-held light, either battery operated or wired to the wall socket, for the purpose of matching shades with 6500 Kelvin and for tooth whitening with color corrected light.

The foregoing has outlined, in general, the physical aspects of the invention and is meant to serve as an aid to better understanding of the more complete detailed description which follows. In reference to such, there is to be a clear understanding that the present invention is not limited to the method or details of construction, fabrication, material, or application of use described and illustrated herein. Any other variation of fabrication, use, or application should be considered apparent as an alternative embodiment of the present invention.

Other objects and features of the invention will be in part apparent and in part pointed out hereinafter.

### BRIEF DESCRIPTION OF THE DRAWINGS

The features and advantages of the invention will be readily apparent from the following detailed description. The detailed description will be better understood in relation to the accompanying drawings as:

FIG. 1 is a perspective view of the assembled dental whitening light in this invention. It consists of the stand 10, the arm 20, the light head 30, the control box 40, the mouth piece 50 and the handling connector 60.

FIG. 2 is the enlarged view of the light head of FIG. 1. The head connection bar 31 connects with the azimuthally adjustable arm 20 by a ball-in-socket joint connection so that the position of the LED diodes 32 can be easily adjusted in all azimuthal directions needed by positioning the connector 31 until the mouth piece 33 of the light head is adjusted to reach the required position closely near the patient's mouth.

FIG. 3 illustrates how the LED light with detachable mouth shield piece 33 (not shown) is used to whiten the patient's teeth (A) and how the LED light with detachable mouth shield piece is used to color-correct the patient's teeth (B). The position of the LED detachable mouth shield piece 33 should be adjusted to reach the mouth of the patient perfectly so that all the light from the LEDs will travel through into the mouth for whitening purposes; otherwise, the detachable mouth shield piece should be positioned near the mouth of the patient, leaving an appropriate distance while minimizing the effect of the ambient light for the true color matching.

FIG. 4 illustrates the importance of using the appropriate illumination source. If a 5500 to 6500 Kelvin color-corrected source is used, the color is represented perfectly without aberration, as seen with ambient daylight from a northern sky (seen as on Photo A). Photo B represents the color shown with a typical fluorescent light source, while Photo C represents the color shown with a typical incandescent light source

FIG. 5 is the perspective view of the control box. A variety of functions on the light head can be easily controlled by the buttons on the control panel 41. All the electronic drives and circuits are arranged inside the housing 42. The functions of the control box include an on-off switch, whitening/color-correction choice, working time duration, pulse-or-continuous choice, etc. An LCD display widow can be added to show the response of the function buttons.

### DETAILED DESCRIPTION OF THE INVENTION

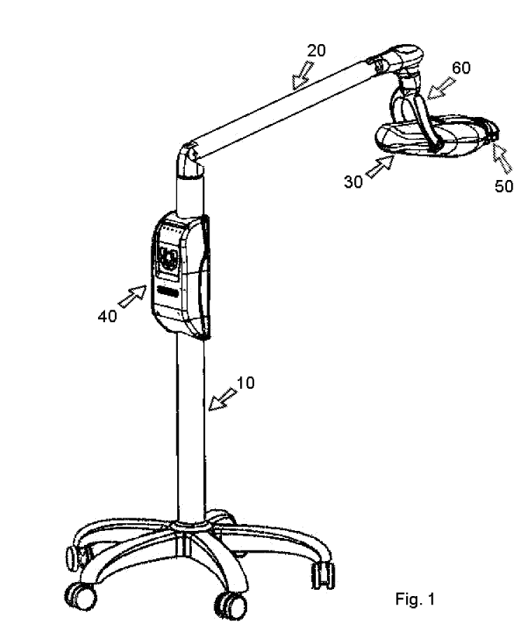

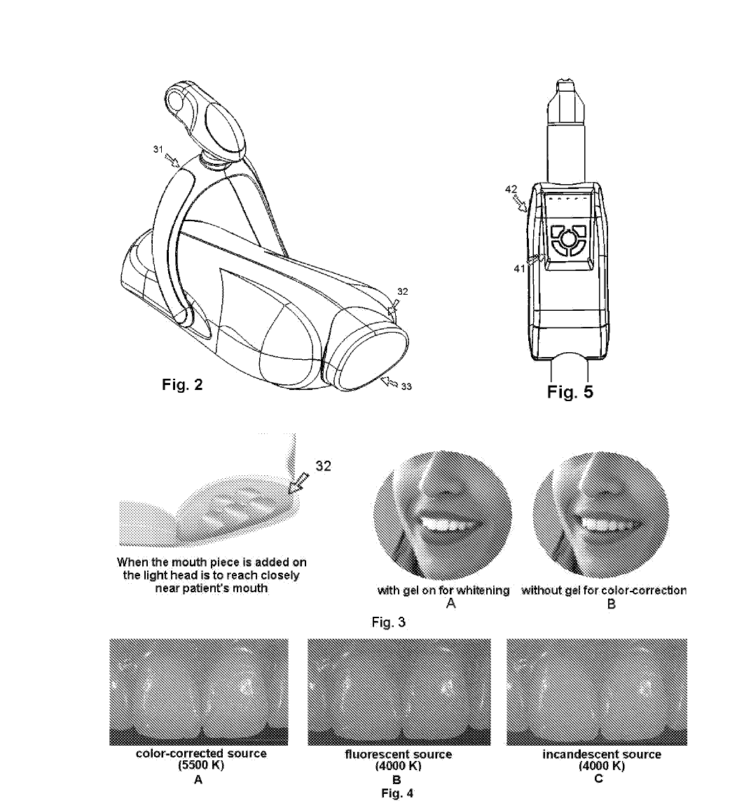

The light head shown in FIG. 2 is attached to a bar at the end of the arm in FIG. 1 to get the position needed in such a way as follows. The stand in FIG. 1 is movable in horizontal directions with wheels attached to its proximal end or without wheels. The arm is pivoted on the upper end of the stand, adjustable in both horizontal and vertical azimuthal directions. The light head is connected at the end of the arm in a ball-in-socket joint, allowing position adjustment as required so that the light head which is connected to the adjusted arm can stay in any position for viewing the teeth or tissue that a practitioner may need. Hence the light head can always be positioned to shine the light directly on the tooth surface.

The LED light head could have a detachable shield, which could be similar to the mouth shield piece shown in FIG. 3, to eliminate ambient light that would affect the proper matching of any shade. Only the 5500 to 6500 Kelvin light would reach the patient. The light itself is bright enough when placed within 6 cm of the patient's teeth or other tissue and, under these circumstances, does not need a shield. The detachable mouth shield piece could be either disposable or autoclavable to easily prevent possible cross-infection between the patients.

In FIG. 4, the photos under different illumination show why the dentist needs to use a color-corrected source to help judge the tooth color precisely. To do this, the light stand is positioned in front of a patient for the view of the teeth at a predetermined distance to be used for color matching with true daylight. For whitening purpose, the light head is positioned close to the patient's teeth, accelerating the tooth whitening process by the addition of photo-accelerators to increase the decomposition of H₂O₂ or other peroxide or whitening material currently used for teeth whitening in the dental office.

A variety of functions on the light head can be easily controlled by the control box which is shown in FIG. 5. The functions could include on-off switch, whitening/color-correction choice, working time duration, and pulse/continuous choice. An LCD display widow can be added to show the response of the function buttons.

It will also be understood that, in addition to color matching of teeth and tissue, the light could be used wherever true daylight is needed to view objects in the best light or standard true color corrected lighting. The device can be used to accelerate the whitening procedures in dental offices and cure restorative materials like composite fillers, sealants or other light cured material.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

It is intended that any other advantages and objects of the present invention that become apparent or obvious from the detailed description or illustrations contained herein are within the scope of the present invention.

We claim:

1. A device for whitening teeth comprising:
a movable stand with an adjustable arm with an adjustable light head attached at the end of the arm;
the LED diodes inside said light head whose function is the whitening of teeth or color matching or overhead dental light with no UV output;

2. The whitening device of claim 1, wherein:
said light head operates on both arches simultaneously and accelerates the tooth whitening procedure with the addition of photo-sensitive accelerators;

3. The whitening device of claim 1, wherein:
said light head provides a portable “daylight” or color corrected light at 5500 to 6500 Kelvin, while blocking or overwhelming ambient light, for true shade (color) matching of teeth and restorations in any room in the dental office;

4. The whitening device of claim 3, wherein:
said light head provides a true color corrected daylight at 5500 to 6500 Kelvin for use in tissue diagnosis;

5. The whitening device of claim 1, wherein:
said device is, optionally, set on wheels to move easily from room to room and could be used at home or in a salon for make-up as well as in a medical setting;

6. The whitening device of claim 3, wherein:
said light head can be used additionally to take a digital picture by a digital camera with the color corrected light and import that picture into a computer where it can be matched to a tooth shade guide such as the Vita Shade™ or any other appropriate guide;

7. The whitening device of claim 3, wherein:
said light head, which consists of said LED diodes located inside the housing of said light head and a detachable distal front portion located at the opening of said housing in order to provide different LEDs to either cure or whiten teeth;

8. The whitening device of claim 7, wherein:
said detachable distal front portion can include a mouth piece shield that sets the distance to the patient's teeth and blocks out ambient light, and that is either disposable or autoclavable to prevent the possible cross-infection between patients;

9. The whitening device of claim 3, wherein:
said light head, if combined with a convergent lens, could also serve as an over head operatory light in the dental office, which would provide no UV output and more effective illumination than a regular halogen dental light;

10. The whitening device of claim 1, wherein:
said device is divided into a stand movable with wheels or without wheels, an arm pivoted on the upper end of said stand, so that it is adjustable in both horizontal and vertical azimutal directions, and a light head that is connected in a ball-in-socket joint at the end of said arm, allowing position adjustment as required so that said light head stays in any position for viewing the teeth or tissue that a practitioner may need;

11. The whitening device of claim 1, wherein:
said device includes a control box attached on the said lower stand or any other convenient location on the frame;

12. The whitening device of claim 11, wherein:
said control box contains electrical circuits, control buttons and LCD displays to control the intensity, duration of operation, and other characteristics of said LED diodes in said light head.

13. The whitening device of claim 1, wherein:
this professional office-using device, for home use or other portable convenience, can be reduced to a hand-held light, either battery operated or wired to the wall socket, for the purpose of matching shades with 6500 Kelvin and for tooth whitening with color corrected light.
